(19) United States
(12) Patent Application Publication
(10) Pub. No.: US 2015/0085534 A1
(43) Pub. Date: Mar. 26, 2015

(54) REGENERATIVE AND RAMPING ACCELERATION (RARA) SNUBBERS FOR ISOLATED AND TAPPED-INDUCTOR CONVERTERS

(71) Applicants: Alexander ABRAMOVITZ, Irvine, CA (US); Keyue M. Smedley, Irvine, CA (US); Chaitania Vartak, IRVINE, CA (US)

(72) Inventors: Alexander ABRAMOVITZ, Irvine, CA (US); Keyue M. Smedley, Irvine, CA (US); Chaitania Vartak, IRVINE, CA (US)

(21) Appl. No.: 14/490,649

(22) Filed: Sep. 18, 2014

Related U.S. Application Data
(60) Provisional application No. 61/880,759, filed on Sep. 20, 2013.

(51) Int. Cl. H02M 1/34; H02M 3/335

(52) U.S. Cl. CPC H02M 1/34; H02M 3/33507; H02M 2001/342
USPC 363/21.01

(57) ABSTRACT

A voltage converter circuit comprising a primary inductor; a secondary inductor, at least a portion of the second inductor being mutually coupled to the primary inductor; a rectifier diode connected to the secondary inductor such that the rectifier diode turns off when current flows in the secondary inductor in a first direction; and a snubber circuit arranged to charge a first snubber capacitor with the current flowing through the secondary inductor after the rectifier diode turns off; the snubber circuit being arranged to discharge the first snubber capacitor by complementing the current in the secondary inductor after the flow of the current in the secondary inductor is inverted.

### CROSS REFERENCE TO RELATED APPLICATIONS

This application is a non-provisional and claims priority of U.S. provisional application No. 61/880,759, filed Sep. 20, 2013, which is incorporated herein as though set forth in full.

### FIELD OF THE INVENTION

The present invention relates generally to voltage converter circuits having coupled inductors, and in particular to a regenerative and ramping acceleration (RARA) snubber circuit for switching converters with either isolation transformer(s) or tapped inductor(s). A snubber circuit according to the present disclosure can reduce the stress of the switching devices in a switching converter, can accelerate the output current ramping, and can improve the overall efficiency of the hosting switching converter. A snubber circuit according to the present disclosure can assist the output rectifier to achieve zero voltage turn on and zero current turn off, can recycle the absorbed leakage energy back to the hosting switching converters, can provide fast output current ramping, and can improve the overall efficiency.

### BACKGROUND

Numerous voltage converters, or voltage converter circuits, use magnetic components with multiple coupled windings such as transformers and coupled inductors. These magnetic components practically include an equivalent leakage inductance in series with each winding. The leakage inductance can cause several problems in switching converters.

As the winding current is interrupted by a switch, the leakage inductance has to discharge its energy into the switch and surrounding stray capacitances in the circuit. This may result in a large voltage overshoot and ringing across the switch. Generally, the overshoot and ringing may shorten the lifetime of the switch and in severe cases may exceed the switch rating causing destruction. The ringing may also emit electro-magnetic interference (EMI) and can disturb the operation of nearby systems.

Further, as a switch or diode is turned on, the leakage inductance can impede the ramping of the current in a winding. The delay of the secondary current ramping may shorten the conduction time of the output rectifier. As a result, a considerable amount of energy can be prevented from being delivered to the output. Consequently, the practical voltage conversion ratio may fall short from that of the expected. To compensate for this effect, the converter may have to be operated at higher duty cycle, which can elevate conduction losses and impair the efficiency. At higher power the problem may be more severe, since current ramping delay can become longer as the output current needs to be ramped to a higher value.

This output current ramping problem may become acute in transformer isolated or tapped inductor converters with high step-up ratio. This is because in these applications the transformer or tapped inductor may be designed with high turns ratio and can have a substantial secondary leakage that can severely restrict the output current build-up and may impair energy transfer to the output. Hence, the performance of the converter with multi-winding magnetic structure can be profoundly affected by the leakage inductances.

A common industry practice is using a RC clamp circuit to absorb the leakage energy and so limit the voltage stress across the main switch of the flyback transformer. However, RC clamp dissipates the absorbed energy which is lost to heat. Thus, the converter efficiency is impaired. Typically, efficiency may be in the 75-80% range.

To handle the transients caused by the primary winding leakage inductance, snubber circuit may be utilized to absorb the leakage energy while preventing overvoltage providing controllable rate of voltage rise dV/dt across the switch, and alleviating switching loss of the semiconductor devices. Known snubber circuits, such as disclosed in “K. M. Smith, C. Ji, and K. M. Smedley, “Energy regenerative clamp for flyback Converter”, VCI, invention disclosure, September 1998” or in “C. Liao, K. Smedley, “Design of high efficiency Flyback converter with energy regenerative snubber,” in Proc. IEEE App. Power Electron. Conf. and Expo. APEC′08, 2008”, are typically designed to capture the energy stored in the leakage inductance of the primary winding of a transformer and recycle it to the circuit while suppressing the voltage spike and ringing across the active power switch. However, known snubber circuits provide no solution to the problem of the output current ramping delay caused by the secondary leakage inductance and its impact on converter performance.

### SUMMARY

The present disclosure relates to a snubber circuit for a voltage converter, the snubber circuit being provided to charge a capacitor with the current flowing through the secondary inductance (or inductor) of the converter after a rectifier diode of the converter is turned off by said current; the snubber circuit being arranged to discharge the capacitor by complementing the current in the secondary inductor after the flow of the current in the secondary inductor is inverted.

An embodiment of the present disclosure relates to a voltage converter circuit comprising: a primary inductor; a secondary inductor, at least a portion of the second inductor being mutually coupled to the primary inductor; a rectifier diode connected to the secondary inductor such that the rectifier diode turns off when current flows in the secondary inductor in a first direction; and a snubber circuit arranged to charge a first snubber capacitor with the current flowing through the secondary inductor after the rectifier diode turns off; the snubber circuit being arranged to discharge the first snubber capacitor by complementing the current in the secondary inductor after the flow of the current in the secondary inductor is inverted.

According to an embodiment of the present disclosure, the secondary inductor comprises an inductor portion mutually coupled to the primary inductor and a leakage inductor in series with said inductor portion.

According to an embodiment of the present disclosure, one of the anode and the cathode of the rectifier diode is connected to a first terminal of the secondary inductor, a first terminal of the first snubber capacitor being connected to said first terminal of the secondary inductor; the snubber circuit comprises a first snubber diode connected between a second terminal of the first snubber capacitor and the other of the anode and the cathode of the rectifier diode, the first snubber diode and the rectifier diode being connected in opposition; and the snubber circuit comprises a second snubber diode connected to the second terminal of the first snubber capacitor, the first and second snubber diodes being connected in series.

According to an embodiment of the present disclosure, the voltage converter circuit comprises an output filter capacitor connected between first and second output terminals.

According to an embodiment of the present disclosure, a second terminal of the secondary inductor is connected to a first terminal of the primary inductor, wherein the first output terminal is connected to the other of the anode and the cathode of the rectifier diode and wherein the second output terminal is connected to a ground of the voltage converter circuit.

According to an embodiment of the present disclosure, the first and second snubber diodes in series are connected in parallel with the output filter capacitor.

According to an embodiment of the present disclosure, a power source is connected between a second terminal of the primary inductor and said ground, and a switch is connected between the first terminal of the primary inductor and said ground; the snubber circuit comprising a third snubber diode connected in series between the first terminal of the primary inductor and the second snubber diode; and a second snubber capacitor having a first terminal connected between the third and second snubber diodes.

According to an embodiment of the present disclosure, a second terminal of the second snubber capacitor is connected to the second output terminal.

According to an embodiment of the present disclosure, a second terminal of the second snubber capacitor is connected to the first output terminal.

According to an embodiment of the present disclosure, a second terminal of the second snubber capacitor is connected to the first terminal of the primary inductor.

According to an embodiment of the present disclosure, the voltage converter circuit comprises an output filter capacitor connected between first and second output terminals, wherein the first output terminal is connected to the other of the anode and the cathode of the rectifier diode and the second output terminal is connected to a second terminal of the secondary inductor.

According to an embodiment of the present disclosure, the voltage converter circuit comprises an output filter capacitor connected between first and second output terminals, wherein the first output terminal is connected to the first terminal of the secondary inductor and the second output terminal is connected to the other of the anode and the cathode of the rectifier diode via a charge inductor, a second terminal of the secondary inductor being coupled to said other of the anode and the cathode of the rectifier diode via a transfer capacitor.

Embodiments of the present disclosure consist of an electronic component comprising at least the snubber circuit as detailed in the embodiments above.

An embodiment of the present disclosure relates to a method of converting voltage comprising: providing a voltage converter circuit having a primary inductor and a secondary inductor, at least a portion of which is mutually coupled to the primary inductor; and a rectifier diode connected to the secondary inductor such that the rectifier turns off when current flows in the secondary inductor in a first direction; providing a first snubber capacitor; charging said first snubber capacitor with the current flowing through the secondary inductor after the rectifier diode turns off; and discharging the first snubber capacitor by complementing the current in the secondary inductor after the flow of the current in the secondary inductor is inverted.

According to an embodiment of the present disclosure, the secondary inductor comprises an inductor portion mutually coupled to the primary inductor and a leakage inductance in series with said inductor portion.

According to an embodiment of the present disclosure, one of the anode and the cathode of the rectifier diode is connected to a first terminal of the secondary inductor, a first terminal of the first snubber capacitor being connected to said first terminal of the secondary inductor; wherein the snubber circuit comprises a first snubber diode connected between a second terminal of the first snubber capacitor and the other of the anode and the cathode of the rectifier diode, the first snubber diode and the rectifier diode being connected in opposition; and wherein the snubber circuit comprises a second snubber diode connected to the second terminal of the first snubber capacitor, the first and second snubber diodes being connected in series; wherein the current charging said first snubber capacitor flows through the second snubber diode; and wherein the current discharging said second snubber capacitor flows through the first snubber diode.

According to an embodiment of the present disclosure, the method comprises turning on the rectifier diode after the first snubber capacitor is discharged.

According to an embodiment of the present disclosure, a second terminal of the secondary inductor is connected to a first terminal of the primary inductor, wherein a first output terminal is connected to the other of the anode and the cathode of the rectifier diode and wherein a second output terminal is connected to a ground of the voltage converter circuit; wherein a power source is connected between a second terminal of the primary inductor and said ground, and wherein a switch is connected between the first terminal of the primary inductor and said ground; the snubber circuit comprising a third snubber diode connected in series between the first terminal of the primary inductor and the second snubber diode; and a second snubber capacitor having a first terminal connected between the third and second snubber diodes; the method further comprising: charging the second snubber capacitor with the current that flows in the primary inductor after the switch is turned off; and discharging the second snubber capacitor into the first snubber capacitor through the second snubber diode after the rectifier diode is turned off; said charging said first snubber capacitor with the current flowing through the secondary inductor after the rectifier diode turns off comprising charging the first snubber capacitor through the third and second snubber diodes with the current flowing through the secondary inductor after the first snubber capacitor is discharged.

### BRIEF DESCRIPTION OF THE DRAWINGS

The invention(s) may be better understood by referring to the following figures. The components in the figures are not necessarily to scale, emphasis instead being placed upon illustrating the principles of the invention. In the figures, like reference numerals designate corresponding parts throughout the different views.

FIG. 1(a) is a schematic diagram of the structure of an embodiment of a RARA snubber according to the present disclosure.

FIG. 1(b) is a schematic diagram of the structure of another embodiment of a RARA snubber according to the present disclosure.

FIG. 2(a) is a schematic diagram of an application of the RARA snubber of FIG. 1(a) to a diode rectifier with a capacitive filter with positive voltage polarity.

FIG. 2(b) is a schematic diagram of an application of the RARA snubber of FIG. 1(a) to a diode rectifier with a capacitive filter with negative voltage polarity.

FIG. 2(c) is a schematic diagram of application of the RARA snubber of FIG. 1(a) to a voltage converter having a transformer isolated diode rectifier with capacitive filter.

FIG. 2(d) is a schematic diagram of application of the RARA snubber of FIG. 1(a) to a voltage converter having a coupled inductor with diode rectifier and capacitive filter.

FIG. 2(e) is a schematic diagram of application of the RARA snubber of FIG. 1(b) to a coupled inductor boost converter.

FIG. 2(f) is a schematic diagram of another application of the RARA snubber of FIG. 1(b) to a coupled inductor boost converter.

FIG. 2(g) is a schematic diagram of another application of the RARA snubber of FIG. 1(b) to a coupled inductor boost converter.

FIG. 3(a) is a schematic diagram of an application of the RARA snubber of FIG. 1(a) to a Flyback converter.

FIG. 3(b) is a schematic diagram of an application of the RARA snubber of FIG. 1(a) to an isolated SEPIC converter.

FIG. 3(c) is a schematic diagram of an application of the RARA snubber of FIG. 1(a) to an isolated Zeta converter.

FIG. 3(d) is an application of the RARA snubber of FIG. 1(a) to an isolated Cuk converter.

FIG. 3(e) is an application of the RARA snubber of FIG. 1(a) to a coupled inductor boost converter.

FIG. 3(f) is an application of the RARA snubber of FIG. 1(a) to a current fed push-pull converter.

FIG. 3(g) is an application of the RARA snubber of FIG. 1(b) to a coupled inductor boost converter showing also the leakage inductances of the coupled inductor.

FIG. 4(a) is a schematic diagram of a converter with diode rectifier with capacitive filter employing the RARA snubber of FIG. 1(a).

FIG. 4(b) is a schematic diagram showing the current path within the converter of FIG. 4(a) towards the zero current turn-off of the rectifier.

FIG. 4(c) is a schematic diagram showing the current path within the converter of FIG. 4(a) during the snubber charging.

FIG. 4(d) is a schematic diagram showing the current path within the converter of FIG. 4(a) during the main switch conduction.

FIG. 4(e) is a schematic diagram showing the current path within the converter of FIG. 4(a) during the rectifier current ramping.

FIG. 4(f) is a schematic diagram showing the current path within the converter of FIG. 4(a) during the zero voltage turn-on and conduction of the rectifier.

FIG. 5(a) is a schematic diagram of the coupled inductor boost converter of FIG. 2(e) showing the current path during the zero voltage turn off of the main switch.

FIG. 5(b) is a schematic diagram of the coupled inductor boost converter of FIG. 2(e) showing the current path during the first phase of the secondary current ramping.

FIG. 5(c) is a schematic diagram of the coupled inductor boost converter of FIG. 2(e) showing the current path during the second phase of the secondary current ramping.

FIG. 5(d) is a schematic diagram of the coupled inductor boost converter of FIG. 2(e) showing the current path during the rectifier diode, conduction of the secondary current.

FIG. 5(e) is a schematic diagram of the coupled inductor boost converter of FIG. 2(e) showing the current path during the zero current turn on of the main switch, and secondary current falling towards zero current turn off of the rectifier diode.

FIG. 5(f) is a schematic diagram of the coupled inductor boost converter of FIG. 2(e) showing the current path during a first charging phase of the first snubber capacitor and discharging of the second snubber capacitor.

FIG. 5(g) is a schematic diagram of the coupled inductor boost converter of FIG. 2(e) showing the current path during a second charging phase of the first Cs snubber capacitor.

FIG. 5(h) is a schematic diagram of the coupled inductor boost converter of FIG. 2(e) showing the current path during the main switch conduction.

FIG. 6 illustrates a method according to the present disclosure.

### DETAILED DESCRIPTION

A snubber circuit according to embodiments of the present disclosure can help alleviate the above described problems caused by the secondary leakage inductance in transformer isolated or tapped inductor switching converters (isolated or non isolated coupled inductor converters) and can improve their performance. Henceforth, a snubber according to an embodiment of the present disclosure is referred to as Regenerative and Ramping Acceleration (RARA) Snubber.

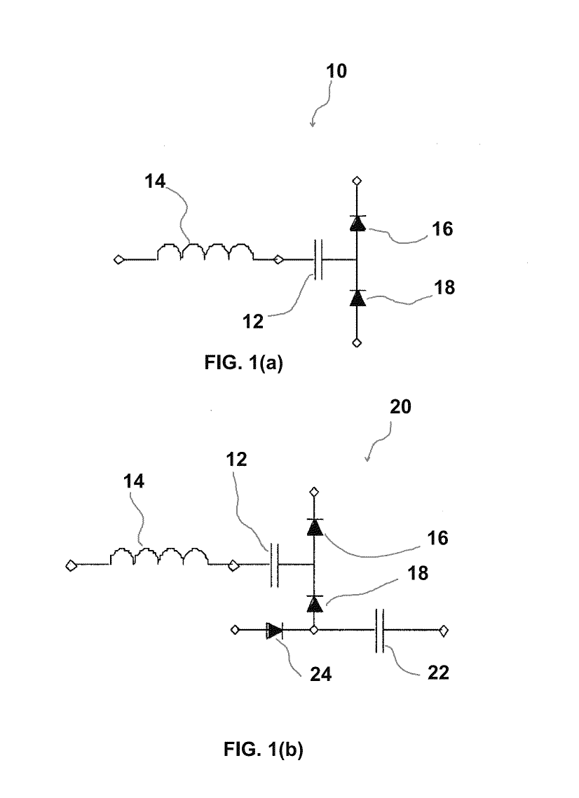

FIG. 1(a) illustrates a snubber circuit, or RARA snubber 10, according to an embodiment of the present disclosure. RARA snubber 10 comprises a first capacitor 12 having a first terminal provided to be connected to a terminal of a secondary inductor of a voltage converter circuit (not shown), the secondary inductor comprising a leakage inductor 14. RARA snubber 10 comprises diode elements 16 and 18 connected in series and also connected each to the second terminal of first capacitor 12.

An embodiment of the present disclosure provides for connecting RARA snubber 10 to a voltage converter circuit (not shown in FIG. 1A) having a primary inductor and a secondary inductor; at least a portion of the second inductor being mutually coupled to the primary inductor; and having a rectifier diode connected to the secondary inductor such that the rectifier diode turns off when current flows in the secondary inductor in a first direction. According to an embodiment of the present disclosure, leakage inductor 14 is the leakage inductor of the secondary inductor of such voltage converter circuit. According to an embodiment of the present disclosure, inductor 14 does not have to be a physical component. According to an embodiment of the present disclosure inductor 14 can be the secondary inductor itself.

According to an embodiment of the present disclosure, RARA snubber 10 is arranged such that first capacitor 12 is charged with the current flowing through the secondary inductor of the converter after the rectifier diode of the converter is turned off; and RARA snubber circuit 10 is arranged to discharge first capacitor 12 by complementing the current in the secondary inductor after the flow of the current in the secondary inductor is inverted.

FIG. 1(b) shows a RARA snubber 20 according to an embodiment of the present disclosure, comprising a second capacitor 22 having a first terminal connected to the second terminal of first capacitor 12 via diode 18; and comprising a third diode element 24 connected in series with diode 18 at the first terminal of second capacitor 22.

According to an embodiment of the present disclosure, the voltage converter (not shown in FIG. 1(b)) to which RARA snubber 20 is provided for being connected to, has a primary switch connected to the primary inductor, wherein the free terminal of diode 24 in FIG. 1(b) is connected between the primary switch and the primary inductor. According to an embodiment of the present disclosure, RARA snubber 20 is arranged such that: a/second capacitor 22 is charged with the current that flows in the primary inductor after the primary switch is turned off; b/second snubber capacitor 22 is discharged into the first snubber capacitor 12 via snubber diode 18 after the rectifier diode is turned off; and c/ first snubber capacitor 12 is charged through snubber diodes 24 and 18 with the current flowing through the secondary inductor after the first snubber capacitor 22 is discharged.

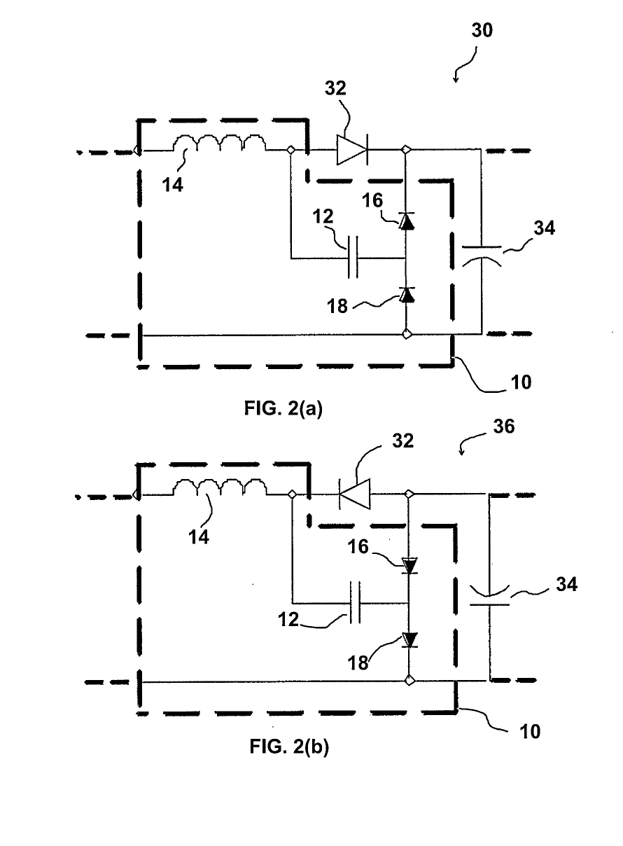

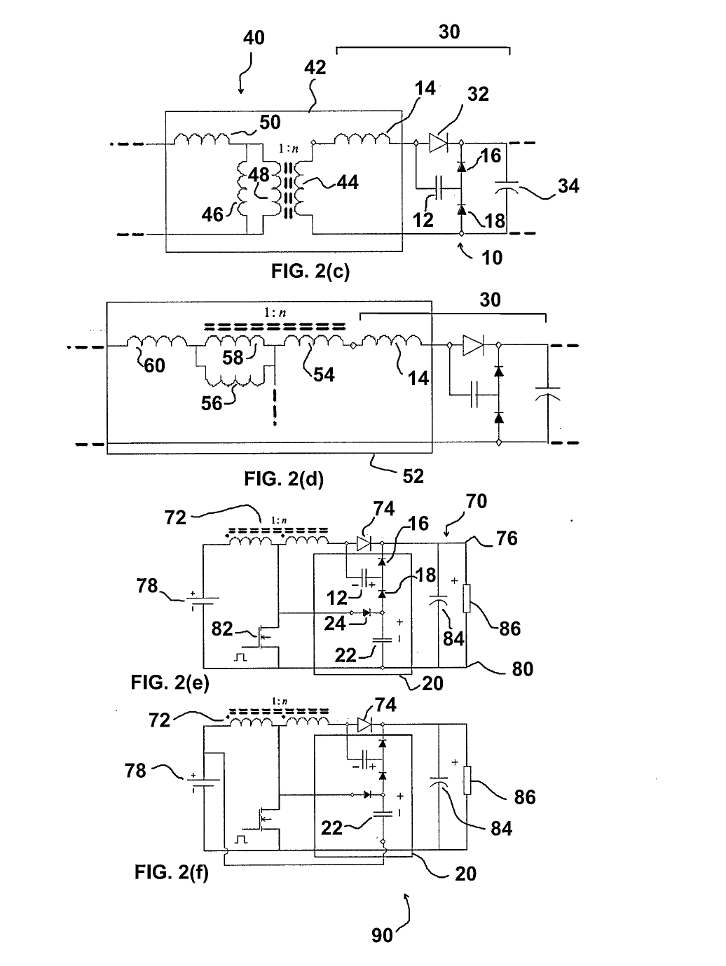

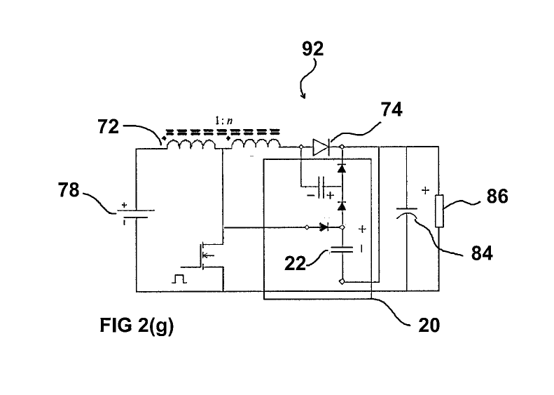

FIG. 2(a) is a schematic diagram of an application of the RARA snubber 10 of FIG. 1(a) to a diode rectifier 30 with a capacitive filter with positive voltage polarity. According to an embodiment of the present disclosure, diode rectifier 30 can form part of a voltage converter (not shown), driven by a coupled inductor or transformers secondary. According to an embodiment of the present disclosure, diode rectifier 30 comprises a rectifier diode 32 and an output filter capacitor 34.

FIG. 2(b) is a schematic diagram of an application of the RARA snubber 10 of FIG. 1(a) to a diode rectifier 36 with a capacitive filter with negative voltage polarity. According to an embodiment of the present disclosure, diode rectifier 30 can form part of a voltage converter (not shown), driven by a coupled inductor or transformers secondary. According to an embodiment of the present disclosure, the diode rectifier 36 differs from diode rectifier 30 in that its rectifier diode 32 is inverted with respect to rectifier diode 32 of diode rectifier 30.

FIG. 2(c) is a schematic diagram of an application of the RARA snubber 10 of FIG. 1(a) to a rectifier 30 as in FIG. 2(a), in a voltage converter 40 having a transformer isolated diode rectifier with capacitive filter, comprising a transformer 42 in output of which rectifier 30 is formed. According to an embodiment of the present disclosure, inductor 14 is the leakage inductance of the secondary inductor 44 of transformer 42, wherein inductance 46 is the inductance of the primary inductor 48 of transformer 42, and inductance 50 the leakage inductance of the primary inductor 48 of transformer 42.

FIG. 2(d) is a schematic diagram of an application of the RARA snubber 10 of FIG. 1(a) to a rectifier 30 as in FIG. 2(a), in a voltage converter having a coupled inductor with diode rectifier and capacitive filter, comprising a coupled inductors connected in series 52, in output of which rectifier 30 is formed. According to an embodiment of the present disclosure, inductor 14 is the leakage inductance of the secondary inductor 54 of the coupled inductors 52, wherein inductance 56 is the inductance of the primary inductor 58 of coupled inductors 52, and inductance 60 the leakage inductance of the primary inductor 58 of coupled inductors 52.

FIG. 2(e) is a schematic diagram of application of the RARA snubber 20 of FIG. 1(b) to a non-isolated coupled inductor converter, in particular a coupled inductor boost converter 70. Boost converter 70 comprises coupled inductors 72 having a secondary inductor output terminal connected to the anode of a rectifier diode 74, the cathode of diode 74 being connected to a first output terminal 76. A primary inductor of coupled inductors 72, coupled in series with the secondary inductor, has an input terminal connected to a power source 78, the power source being connected to a ground of the circuit, itself connected to a second output terminal 80. A switch or power switch 82, such as a power transistor or transistor, connects the output terminal of the primary inductor to the ground and a filter capacitor 84 is connected between first and second output terminals 76, 80. A load 86 is represented connected to first and second output terminals 76, 80.

According to an embodiment of the present disclosure, a first terminal of the first snubber capacitor 12 is connected to the anode of rectifier diode 74; first snubber diode 16 is connected between the second terminal of the first snubber capacitor 12 and the cathode of rectifier diode 74, first snubber diode 16 and rectifier diode 74 being connected in opposition; and second snubber diode 18 is connected to the second terminal of first snubber capacitor 12, first and second snubber diodes 16, 18 being connected in series. According to an embodiment of the present disclosure, third snubber diode 24 is connected in series between the output terminal of the primary inductor and second snubber diode 18; and second snubber capacitor 22 has a first terminal connected between the third and second snubber diodes 24, 18. According to an embodiment of the present disclosure, a second terminal of second snubber capacitor 22 is connected to the ground.

FIG. 2(f) is a schematic diagram of another application of the RARA snubber 20 of FIG. 1(b) to a coupled inductor boost converter 90, which differs from the boost converter 70 of FIG. 2(e) in that the second terminal of second snubber capacitor 22 is connected between the input of the primary and the power supply instead of being connected to the ground.

FIG. 2(g) is a schematic diagram of another application of the RARA snubber 20 of FIG. 1(b) to a coupled inductor boost converter 92, which differs from the boost converter 70 of FIG. 2(e) in that the second terminal of second snubber capacitor 22 is connected to the cathode of rectifier diode 74 instead of being connected to the ground.

According to an embodiment of the present disclosure, RARA snubber 10 or 20 can limit voltage ringing across the rectifier, limit the reverse recovery current of the rectifier diode, provide lossless zero voltage turn-on and lossless zero current turn-off switching conditions for the rectifier, accelerate the secondary winding current build-up, recycle the absorbed energy and/or improve the overall converter's efficiency.

In addition to the above mentioned features RARA snubber 20 can also provide lossless zero voltage turn off of the power switch, lossless zero current turn on of the power switch, capturing and recycling of the primary leakage energy, controlled voltage rate of rise and peak voltage across the switch.

According to an embodiment of the present disclosure, RARA snubber 10 can be employed on the secondary winding of an isolating transformer in, for example, the Flyback, SEPIC, ZETA, Cuk, tapped inductor topologies, and current fed push-pull converters, as shown hereafter. The application of the disclosure is not limited to these topologies/converters as it can be employed in other topologies/converters with multi-winding magnetic devices as well. Also, in the given examples shown herein, it is understood that the leakage inductance of the transformer or tapped inductor may be utilized as the snubber inductance, Ls, similarly to the described above and as illustrated for example in FIG. 2 (c) and in FIG. 2 (d).

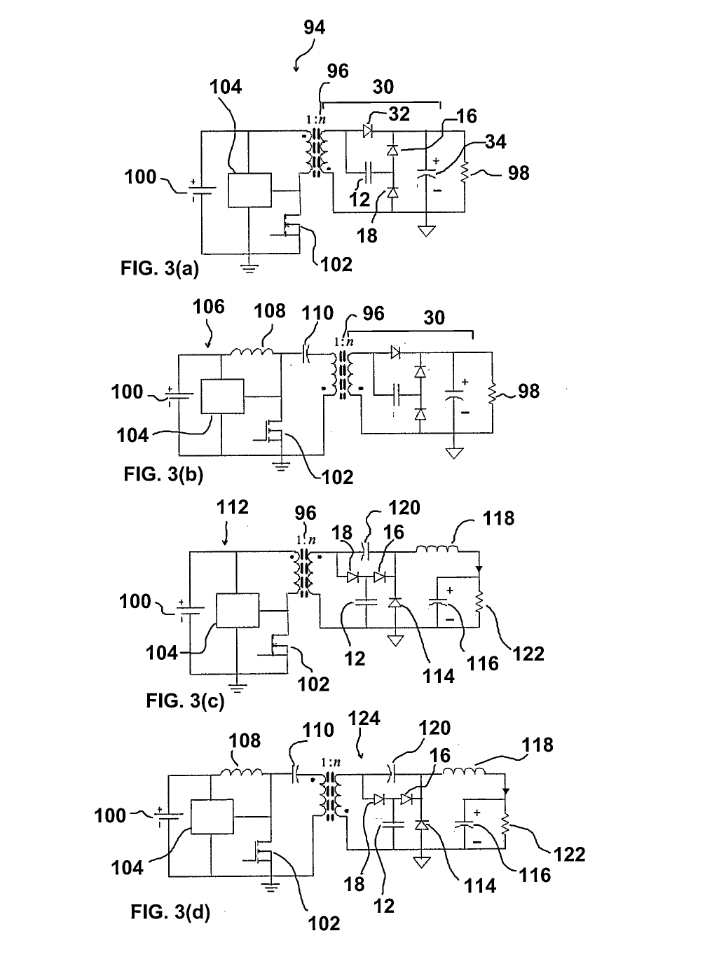

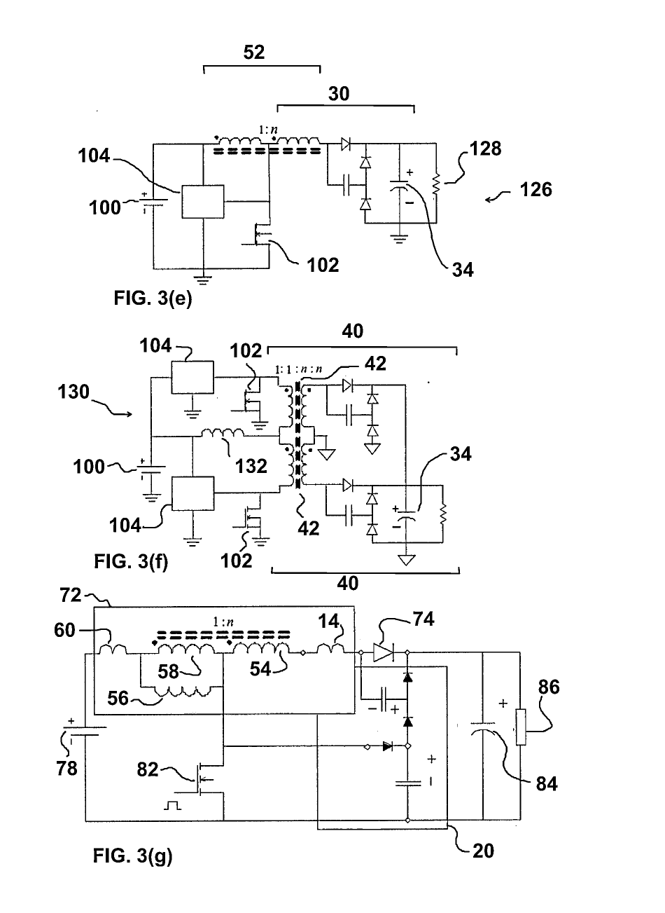

FIG. 3(a) is a schematic diagram of an application of the RARA snubber 10 of FIG. 1(a) to a rectifier 30 as in FIG. 2(a), in a Flyback converter 94. Flyback converter 94 comprises a transformer 96 having a primary inductor and a secondary inductor, at least a portion of the second inductor being mutually coupled to the primary inductor. Rectifier 30 is arranged such that the anode of rectifier diode 32 is connected to a first terminal of the secondary inductor; a first terminal of snubber capacitor 12 is connected to the first terminal of the secondary inductor; first snubber diode 16 is connected between a second terminal of snubber capacitor 12 and the cathode of rectifier diode 32, first snubber diode 16 and rectifier diode 32 being connected in opposition. According to an embodiment of the present disclosure, second snubber diode 18 is connected to the second terminal of snubber capacitor 12, the first and second snubber diodes 16, 18 being connected in series; output filter capacitor 34 is connected between first and second output terminals of converter 94, wherein the first output terminal is connected to the cathode of rectifier diode 34 and the second output terminal is connected to the second terminal of the secondary inductor of transformer 96. In FIG. 3(a), a load 98 is connected between the first and second output terminals of converter 94. According to an embodiment of the present disclosure, the second output terminal of converter 98 is connected to a ground. According to an embodiment of the present disclosure, the primary inductor of transformer 96 has an input terminal connected to a power supply 100 and the primary inductor of transformer 96 has an output terminal connected to a ground via a switch or power switch 102. According to an embodiment of the present disclosure, a snubber circuit 104 is connected between said ground and the input and output terminals of the primary inductor to protect the primary of converter 98.

FIG. 3(b) is a schematic diagram of an application of the RARA snubber 10 of FIG. 1(a) to a rectifier 30 as in FIG. 2(a), in a SEPIC converter 106 that differs from Flyback converter 94 in that the input of the primary inductor is connected to the power supply 100 by a LC circuit and the output of the primary inductor is connected directly to the ground; the LC circuit comprising an inductor 108 connected between the power supply 100 and a middle point and a capacitor 110 connected between the middle point and the input of the primary inductor; the switch 102 being connected between the middle point and the ground and the snubber circuit 104 having one terminal coupled to the ground and two terminals coupled to each side of inductor 108.

FIG. 3(c) is a schematic diagram of an application of the RARA snubber 10 of FIG. 1(a) to an isolated Zeta converter 112. According to an embodiment of the present disclosure, Zeta converter 112 comprises a transformer 96 having a primary inductor and a secondary inductor, at least a portion of the second inductor being mutually coupled to the primary inductor. The anode of a rectifier diode 114 is connected to a first terminal of the secondary inductor; a first terminal of snubber capacitor 12 is connected to the first terminal of the secondary inductor; first snubber diode 16 is connected between a second terminal of snubber capacitor 12 and the cathode of rectifier diode 32, first snubber diode 16 and rectifier diode 32 being connected in opposition. According to an embodiment of the present disclosure, second snubber diode 18 is connected to the second terminal of snubber capacitor 12, the first and second snubber diodes 16, 18 being connected in series; an output filter capacitor 116 is connected between first and second output terminals, wherein the first output terminal is connected to the first terminal of the secondary inductor and the second output terminal is connected to the cathode of the rectifier diode 114 via a charge inductor 118; a second terminal of the secondary inductor being coupled to the cathode of the rectifier diode via a transfer capacitor 120. In FIG. 3(c), a load 122 is connected between the first and second output terminals of converter 112. According to an embodiment of the present disclosure, the first output terminal of converter 112 is connected to a ground. According to an embodiment of the present disclosure, the primary inductor of transformer 96 has an input terminal connected to a power supply 100 and the primary inductor of transformer 96 has an output terminal connected to a ground via a switch or power switch 102. According to an embodiment of the present disclosure, a snubber circuit 104 is connected between said ground and the input and output terminals of the primary inductor to protect the primary of converter 98.

FIG. 3(d) is an application of the RARA snubber of FIG. 1(a) to an isolated Cuk converter that differs from Zeta converter 112 in that the input of the primary inductor is connected to the power supply 100 by a LC circuit and the output of the primary inductor is connected directly to the ground; the LC circuit comprising an inductor 108 connected between the power supply 100 and a middle point and a capacitor 110 connected between the middle point and the input of the primary inductor; the switch 102 being connected between the middle point and the ground and the snubber circuit 104 having one terminal coupled to the ground and two terminals coupled to each side of inductor 108.

FIG. 3(e) is an application of the RARA snubber 10 of FIG. 1(a) to a coupled inductor boost converter 126 as shown in FIG. 2(d). According to an embodiment of the present disclosure, the primary inductor of coupled inductors 52 has an input terminal connected to a power supply 100 and the primary inductor of coupled inductors 52 has an output terminal connected to a ground via a switch or power switch 102. According to an embodiment of the present disclosure, a snubber circuit 104 is connected between said ground and the input and output terminals of the primary inductor to protect the primary of converter 126. According to an embodiment of the present disclosure, a load 128 is connected in output of converter 126 to the terminals of capacitor 34.

FIG. 3(f) is an application of the RARA snubber of FIG. 1(a) to a current fed push-pull converter 130, comprising essentially two voltage converters 40 as in FIG. 2(c) sharing a single output filter capacitor 34, wherein the transformers 42 of the two voltage converters share a common magnetic core. According to an embodiment of the present disclosure, a power supply 100 is connected between a ground and a supply node, the supply node being connected to an input terminal of the primary inductor of each of the transformers 42 via a snubber circuit 104. According to an embodiment of the present disclosure, the input terminal of the primary inductor of each of the transformers 42 is connected to the ground via a switch 102. According to an embodiment of the present disclosure, the output terminals of the primary inductor of each of the transformers 42 are connected to a common point, connected to the supply node via an inductor 132.

FIG. 3(g) is the coupled inductor boost converter 70 of FIG. 2(e), showing the leakage inductances of the coupled inductors 72 consistently with the coupled inductors 52 of FIG. 2(d).

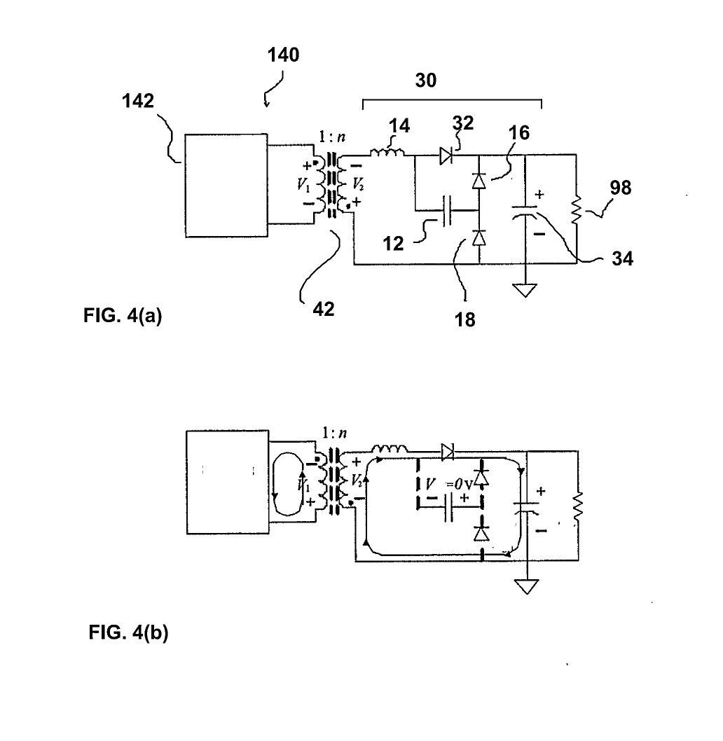

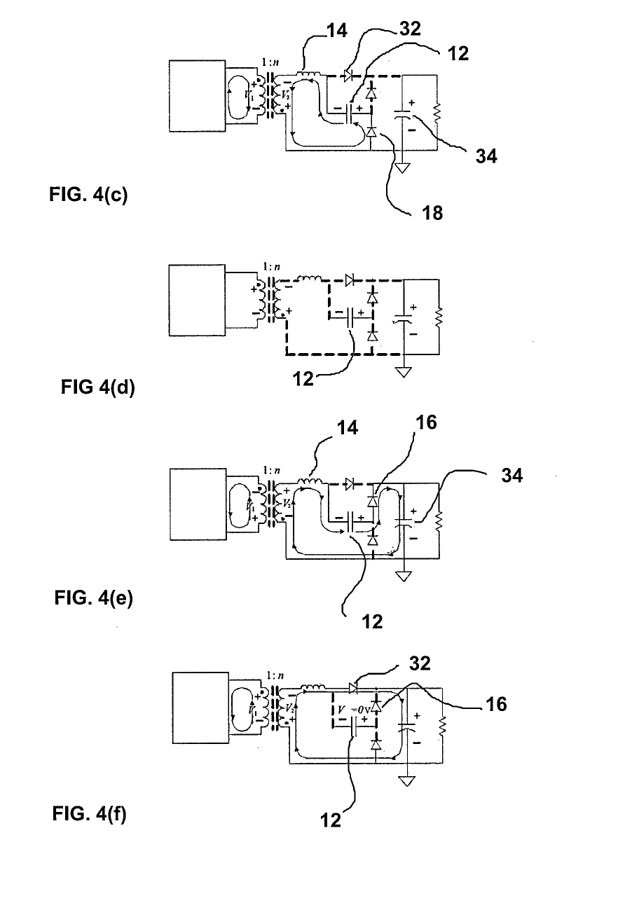

The operation of an embodiment of the present disclosure will now be described in relation with FIGS. 4(a) to 4(f). Application of a RARA snubber circuit 10 as shown in FIG. 1(a), to a generalized Switching Network 140 having a transformer isolated diode rectifier with capacitive filter 30 such as illustrated in FIG. 2(a), connected to a transformer 42 such as illustrated in FIG. 2(c), is illustrated in FIG. 4(a). In this discussion the details of the switching network 140 on the transformer's primary 142 are omitted. Switching network 140 may have diverse practical implementations, for example as shown in FIGS. 3(a) and 3(b), and therefore is expected to introduce some variations in the sequence of events in the RARA snubber circuit, however, a principle of the operation according to an embodiment of the disclosure is as described below.

In the example illustrated, it is assumed that the switch in the primary, such as switch 102 in FIGS. 3(a) and 3(b), is controlled by a high frequency switching signal. At the start of the switching cycle the snubber inductor 14 and the rectifier diode 32 conduct a positive secondary current to the output filter capacitor, 34, as illustrated in FIG. 4(b). At the instant when the switching network 140 imposes a voltage across transformer's primary that causes the voltage of the transformer's secondary to change polarity, the current through inductor 14 and rectifier diode 32 starts ramping down. The snubber inductance 14 can limit the rate of fall of the rectifier diode 32 current. As the current through the rectifier diode 32 falls to zero, zero-current turn-off of the rectifier diode 32 is accomplished.

Upon the rectifier diode 32 cut off, the secondary winding voltage V2 via the diode 18, starts charging the snubber capacitor 12 through resonant action with the inductance 14 as shown in FIG. 4 (c). As the resonant current through capacitor 12 decays to zero, diode 18 turns off at zero current.

After the current ceases, the snubber capacitor 12 remains charged and stores a certain voltage as illustrated in FIG. 4(d), until the switching network 140 initiates a change in the polarity of the transformer's primary voltage.

When, due to action of the switching network 140, the primary voltage, V1, changes polarity, as illustrated in FIG. 4 (e), the secondary voltage, V2, also changes polarity. The stored snubber capacitor voltage then adds to the secondary winding voltage, V2, and develops a resonant current pulse through capacitor 12, inductor 14 and diode 16 into the output filter capacitor 34, as illustrated in FIG. 4(e). According to an embodiment of the present disclosure this resonant discharge of capacitor 12 can help to rapidly ramp up the secondary winding current and results in fast current switch-over from the primary to the secondary winding.

According to an embodiment of the present disclosure, since the switching network 140 can typically include snubbers, fast current switch-over from the primary winding to the secondary winding can reduce energy transfer to the primary snubbers of the switching network 140. The reduced energy circulation in the primary snubbers of the switching network can lower the peak voltage across the switches of switching network as well as improve the switching network efficiency.

As the voltage across the snubber capacitance 12, is discharged to zero, zero voltage turn-on condition is provided for the rectifier diode 32 turn-on, as illustrated in FIG. 4(f).

Whereas diode 16 is turned off at zero current, conduction interval of the rectifier diode 32 can continue until the switching network 140 repeats its switching cycle.

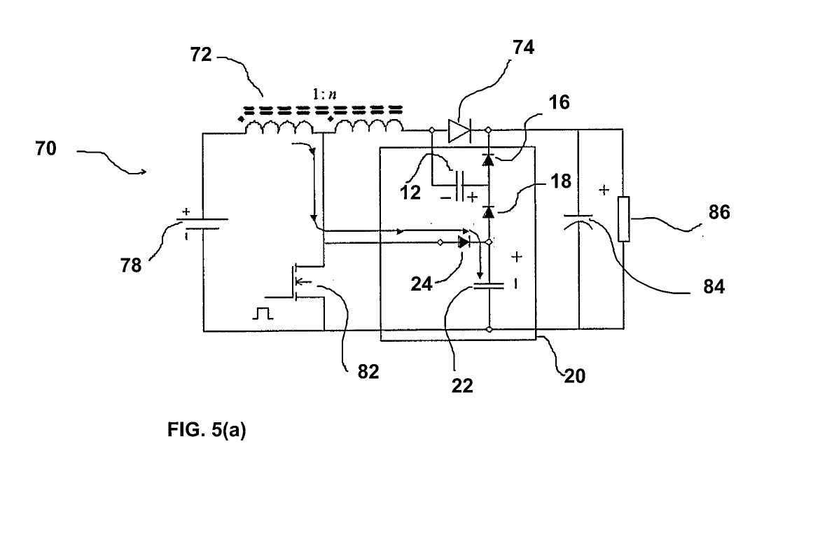

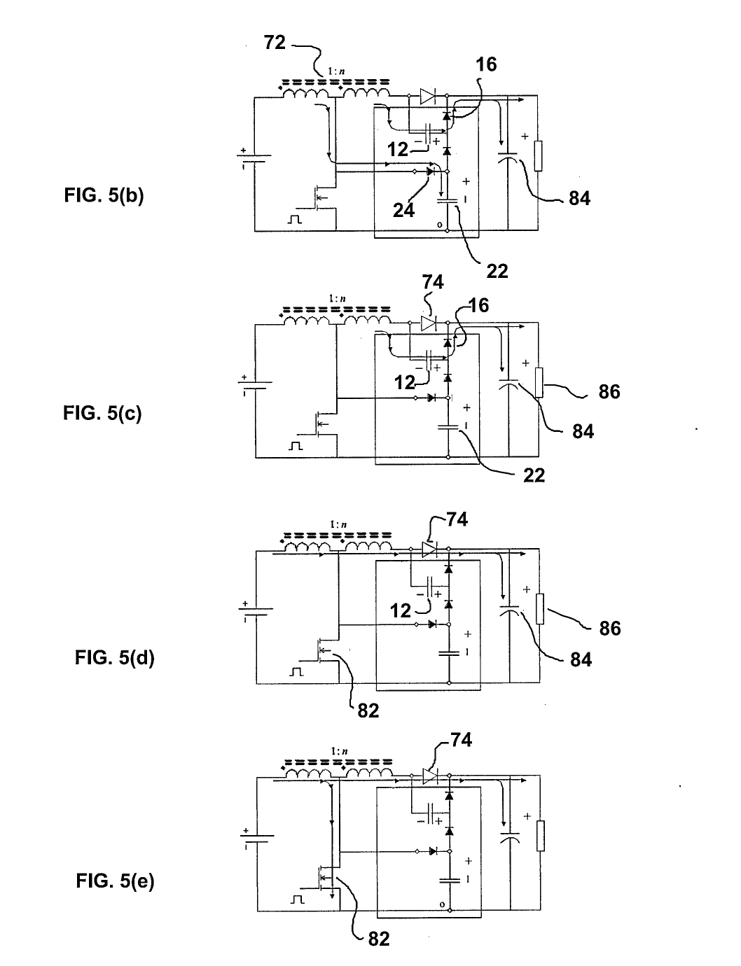

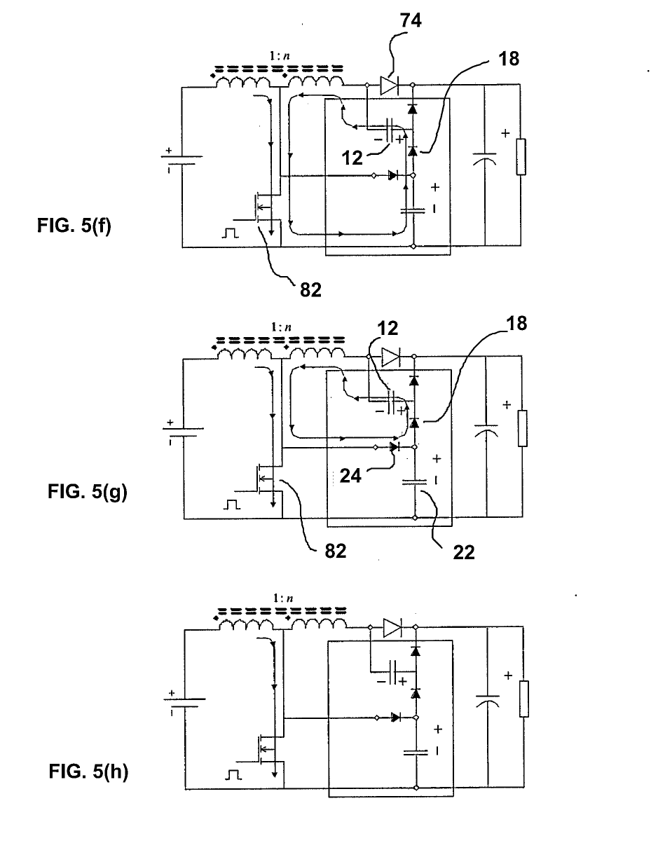

The operation of an embodiment of the present disclosure will now be described in relation with FIGS. 5(a) to 5(h). Application a RARA snubber circuit 20 as shown in FIG. 1(b) according to an embodiment of the present disclosure to a coupled inductor boost converter 70 such as illustrated in FIG. 2(e), is illustrated in FIG. 5(a).

According to an embodiment of the present disclosure, switch 82 is controlled by a high frequency switching signal. Upon turn off of the switch 82, as illustrated in FIG. 5(a), a primary current continues to flow out of a central tap of the coupled inductor 72 via the snubber diode 24 into second snubber capacitor 22. Since, at this state, second snubber capacitor 22 is typically totally discharged and voltage across it is zero, lossless zero voltage turn off of the switch 82 is accomplished. Furthermore, the voltage rise across the switch 82 is limited by the rate of charge of second snubber capacitor 22, as is the switch peak voltage.

According to an embodiment of the present disclosure, certain instant voltage of the central tap of the coupled inductor 72 can become sufficiently high to forward bias the snubber diode 16, via positively charged snubber capacitor 12, as illustrated in FIG. 5(b). At this instant secondary current commences to flow. The high voltage of snubber capacitor 12 adds to the voltage across the secondary. As a result, the higher voltage across the secondary leakage significantly speeds up the rising of the secondary current.

According to an embodiment of the present disclosure, when all or almost all of the energy of the primary leakage inductance is captured by second snubber capacitor 22, the central tap current ceases, as illustrated in FIG. 5(c), whereas the secondary current continues flowing through capacitor 12 and diode 16 to the output filter capacitor 84 and load 86R.

According to an embodiment of the present disclosure, when the secondary current discharges snubber capacitor 12 and voltage across it falls to zero or near zero, the power diode, or rectifier diode, 74, turns on at zero or near-zero voltage as illustrated in FIG. 5(d). Diode 74 then starts carrying the secondary current and allows the coupled inductor to discharge its energy to the output filter capacitor 84 and the load 86.

According to an embodiment of the present disclosure, when the switch 82 is turned on as illustrated in FIG. 5(e), the turn-on occurs at lossless zero current condition. From this moment or instant the coupled inductor primary current starts ramping up, whereas the secondary current starts ramping down. When the secondary current falls to zero, the power diode 74 is turned off at lossless zero or near zero current conditions.

According to an embodiment of the present disclosure, after the rectifier diode 74 turns off, the secondary current flows through the switch 82 and snubber diode 18, so that snubber capacitor 12 is charged, whereas snubber capacitor 22 is discharged, as illustrated in FIG. 5(f).

According to an embodiment of the present disclosure, the charge stored by capacitor 22 is removed and transferred to capacitor 12. Hence, the leakage energy captured earlier by snubber capacitor 22 is recycled.

According to an embodiment of the present disclosure, upon total or nearly total discharge of snubber capacitor 22, the secondary current flows through diodes 24 and 18, as illustrated in FIG. 5(g), and by resonance with the secondary leakage inductance, snubber capacitor 12 continues to pre-charge to its maximum voltage.

According to an embodiment of the present disclosure, then, the switch 82 remains in the on state and continues charging the coupled inductor primary, as illustrated in FIG. 5(h), until the controller commands it to off. Henceforth, the described above cycle of events can then repeat.

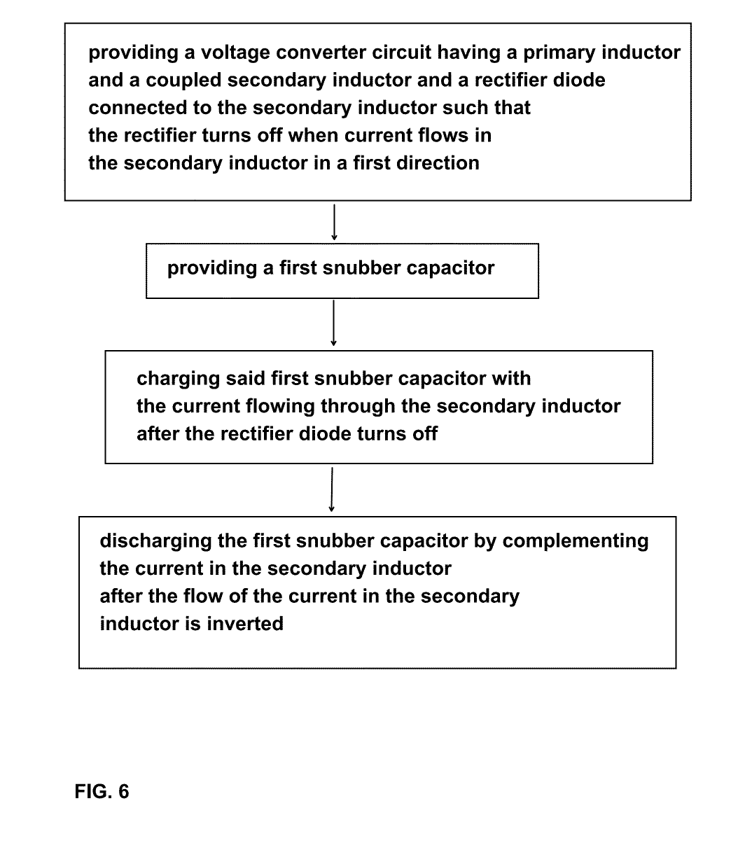

FIG. 6 illustrates a method according to the present disclosure, comprising providing a voltage converter circuit having a primary inductor and a secondary inductor, at least a portion of which is mutually coupled to the primary inductor; and a rectifier diode connected to the secondary inductor such that the rectifier turns off when current flows in the secondary inductor in a first direction, such as illustrated in FIGS. 1-5.

According to an embodiment of the present disclosure, the method further comprises providing a first snubber capacitor such as capacitor 12 as illustrated in FIGS. 1-5; charging said first snubber capacitor with the current flowing through the secondary inductor after the rectifier diode turns off; and discharging the first snubber capacitor by complementing the current in the secondary inductor after the flow of the current in the secondary inductor is inverted.

According to an embodiment of the present disclosure, the topology of a Regenerative Snubber with Fast Output Current Ramping for Isolated Step-up Converters can, for example, recycle the absorbed energy, facilitate lossless switching conditions, and limit the switch voltage stress. Some benefits of a snubber circuit according to an embodiment of the present disclosure include, but are not limited to, a reduced switch voltage stress and higher efficiency. For example only, preliminary experiments showed that when fitted with a snubber circuit according to an embodiment of the present disclosure, the efficiency of a flyback converter can exceed 90%.

The circuits and methods according to embodiments of the present disclosure can be used to increase the efficiency of transformer isolated DC-DC power processing units. The circuits and methods according to embodiments of the present disclosure can be used in a wide range of commercial, industrial and military applications, and include, but are not limited to, applications which require generation of high DC voltage from low DC voltage source or vice versa. Circuits according to embodiments of the present disclosure can include, but are not limited to, for example, power processors for solar power generation, high voltage laser chargers, copiers and flashlights.

While inductors, capacitors, diodes and resistors are discussed, these may be substituted with one or more circuit elements having similar or equivalent features and/or characteristics. For example only, any inductor disclosed herein may be substituted with any inductive element that exhibits inductive characteristics, capacitors may be substituted with any capacitive element that exhibits capacitive characteristics, diodes may be substituted with any a diode element that exhibits diode characteristics, and resistors may be substituted with any resistive element that exhibits resistive characteristics. For example only, any of the circuit elements disclosed herein may be implemented by transistors or other elements.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated.

It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . . ”

It should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art

1. A voltage converter circuit comprising:
a primary inductor;
a secondary inductor, at least a portion of the second inductor being mutually coupled to the primary inductor;
a rectifier diode connected to the secondary inductor such that the rectifier diode turns off when current flows in the secondary inductor in a first direction; and
a snubber circuit arranged to charge a first snubber capacitor with the current flowing through the secondary inductor after the rectifier diode turns off; the snubber circuit being arranged to discharge the first snubber capacitor by complementing the current in the secondary inductor after the flow of the current in the secondary inductor is inverted.

2. The voltage converter circuit of claim 1, wherein the secondary inductor comprises an inductor portion mutually coupled to the primary inductor and a leakage inductor in series with said inductor portion.

3. The voltage converter circuit of claim 1, wherein one of the anode and the cathode of the rectifier diode is connected to a first terminal of the secondary inductor, a first terminal of the first snubber capacitor being connected to said first terminal of the secondary inductor;
wherein the snubber circuit comprises a first snubber diode connected between a second terminal of the first snubber capacitor and the other of the anode and the cathode of the rectifier diode, the first snubber diode and the rectifier diode being connected in opposition; and
wherein the snubber circuit comprises a second snubber diode connected to the second terminal of the first snubber capacitor, the first and second snubber diodes being connected in series.

4. The voltage converter circuit of claim 3, comprising an output filter capacitor connected between first and second output terminals.

5. The voltage converter circuit of claim 4, wherein a second terminal of the secondary inductor is connected to a first terminal of the primary inductor, wherein the first output terminal is connected to the other of the anode and the cathode of the rectifier diode and wherein the second output terminal is connected to a ground of the voltage converter circuit.

6. The voltage converter circuit of claim 5, wherein the first and second snubber diodes in series are connected in parallel with the output filter capacitor.

7. The voltage converter circuit of claim 5, wherein a power source is connected between a second terminal of the primary inductor and said ground, and wherein a switch is connected between the first terminal of the primary inductor and said ground;
the snubber circuit comprising a third snubber diode connected in series between the first terminal of the primary inductor and the second snubber diode; and a second snubber capacitor having a first terminal connected between the third and second snubber diodes.

8. The voltage converter circuit of claim 7, wherein a second terminal of the second snubber capacitor is connected to the second output terminal.

9. The voltage converter circuit of claim 7, wherein a second terminal of the second snubber capacitor is connected to the first output terminal.

10. The voltage converter circuit of claim 7, wherein a second terminal of the second snubber capacitor is connected to the first terminal of the primary inductor.

11. The voltage converter circuit of claim 3, comprising an output filter capacitor connected between first and second output terminals, wherein the first output terminal is connected to the other of the anode and the cathode of the rectifier diode and the second output terminal is connected to a second terminal of the secondary inductor.

12. The voltage converter circuit of claim 3, comprising an output filter capacitor connected between first and second output terminals, wherein the first output terminal is connected to the first terminal of the secondary inductor and the second output terminal is connected to the other of the anode and the cathode of the rectifier diode via a charge inductor, a second terminal of the secondary inductor being coupled to said other of the anode and the cathode of the rectifier diode via a transfer capacitor.

13. An electronic component comprising at least the snubber circuit of claim 1.

14. An electronic component comprising at least the snubber circuit of claim 3.

15. An electronic component comprising at least the snubber circuit of claim 7.

16. A method of converting voltage comprising:
providing a voltage converter circuit having a primary inductor and a secondary inductor, at least a portion of which is mutually coupled to the primary inductor; and a rectifier diode connected to the secondary inductor such that the rectifier turns off when current flows in the secondary inductor in a first direction;
providing a first snubber capacitor;
charging said first snubber capacitor with the current flowing through the secondary inductor after the rectifier diode turns off; and
discharging the first snubber capacitor by complementing the current in the secondary inductor after the flow of the current in the secondary inductor is inverted.

17. The method of claim 16, wherein the secondary inductor comprises an inductor portion mutually coupled to the primary inductor and a leakage inductance in series with said inductor portion.

18. The method of claim 17, wherein one of the anode and the cathode of the rectifier diode is connected to a first terminal of the secondary inductor, a first terminal of the first snubber capacitor being connected to said first terminal of the secondary inductor;
wherein the snubber circuit comprises a first snubber diode connected between a second terminal of the first snubber capacitor and the other of the anode and the cathode of the rectifier diode, the first snubber diode and the rectifier diode being connected in opposition; and
wherein the snubber circuit comprises a second snubber diode connected to the second terminal of the first snubber capacitor, the first and second snubber diodes being connected in series;
wherein the current charging said first snubber capacitor flows through the second snubber diode; and
wherein the current discharging said second snubber capacitor flows through the first snubber diode.

19. The method of claim 17, comprising turning on the rectifier diode after the first snubber capacitor is discharged.

20. The method of claim 19, wherein a second terminal of the secondary inductor is connected to a first terminal of the primary inductor, wherein a first output terminal is connected to the other of the anode and the cathode of the rectifier diode and wherein a second output terminal is connected to a ground of the voltage converter circuit;
wherein a power source is connected between a second terminal of the primary inductor and said ground, and wherein a switch is connected between the first terminal of the primary inductor and said ground;
the snubber circuit comprising a third snubber diode connected in series between the first terminal of the primary inductor and the second snubber diode; and a second snubber capacitor having a first terminal connected between the third and second snubber diodes;
the method further comprising:
charging the second snubber capacitor with the current that flows in the primary inductor after the switch is turned off; and
discharging the second snubber capacitor into the first snubber capacitor through the second snubber diode after the rectifier diode is turned off;
said charging said first snubber capacitor with the current flowing through the secondary inductor after the rectifier diode turns off comprising charging the first snubber capacitor through the third and second snubber diodes with the current flowing through the secondary inductor after the first snubber capacitor is discharged.
